(19) United States
(12) Patent Application Publication
(10) Pub. No.: US 2026/0051251 A1
(43) Pub. Date: Feb. 19, 2026

(54) APPARATUS AND METHOD FOR PROVIDING TRAFFIC SAFETY INFORMATION

(71) Applicants: HYUNDAI MOTOR COMPANY, Seoul (KR); KIA CORPORATION, Seoul (KR)

(72) Inventor: Tae Heon Kim, Hwaseong-si (KR)

(73) Assignees: HYUNDAI MOTOR COMPANY, Seoul (KR); KIA CORPORATION, Seoul (KR)

(21) Appl. No.: 19/202,504

(22) Filed: May 8, 2025

(30) Foreign Application Priority Data
Aug. 13, 2024 (KR) 10-2024-0108529

(51) Int. Cl. G08G 1/16; G08G 1/01; H04N 7/18

(52) U.S. Cl. CPC G08G 1/164; G08G 1/0108; G08G 1/0141; G08G 1/0145; G08G 1/166; H04N 7/18

(57) ABSTRACT

An apparatus and method provide traffic safety information. The apparatus according to various embodiments of the present disclosure includes: a communication unit configured to communicate with at least one of a vehicle and a server; and a control unit configured to select a section with poor sight distance in a road, identify queue information in an area adjacent to the section with poor sight distance, and provide traffic safety information based on the section with poor sight distance and the queue information.

### CROSS-REFERENCE TO RELATED APPLICATION

This application claims priority to and the benefit of Korean Patent Application No. 10-2024-0108529, filed on Aug. 13, 2024, the disclosure of which is incorporated herein by reference in its entirety.

### BACKGROUND

### 1. Technical Field

Various embodiments of the present disclosure relate to an apparatus and a method for providing comprehensive traffic safety information that may occur in relation to a vehicle and sight distance section.

### 2. Discussion of Related Art

Sight distance refers to the length of a road that the driver may see ahead, and the types of sight distance include stop sight distance, overtaking sight distance, escaping sight distance, and decision sight distance.

Currently, some road sections have insufficient vertical and horizontal alignment, resulting in sections with poor sight distance in which the driver's sight distance is not secured. Accordingly, when there are queues caused by signal waiting or traffic congestion ahead, drivers may fail to recognize the queues in advance, leading to rear-end collisions.

The statements in this Background section merely provide background information related to the present disclosure and may not constitute prior art.

### SUMMARY

There is a need for a navigation-related system for resolving the issues described above from a vehicle's perspective. The present disclosure aims to identify that a queue of vehicles is generated due to signal waiting and traffic congestion in a section with poor sight distance caused by road geometry or obstacles, and provide a comprehensive traffic safety service, such as stop guidance.

The present disclosure is also directed to providing a queue estimation model that allows for easy estimation of queue information through embodiments of the present disclosure.

The present disclosure is also directed to providing traffic safety information for notification or control to vehicles that are at risk of collision in a section with poor sight distance.

The technical objectives of the present disclosure are not limited to the above, and other objectives that are not described above may become apparent to those of ordinary skill in the art based on the following descriptions.

According to an aspect of the present disclosure, an apparatus for providing traffic safety information includes: a communication unit that communicates with at least one of a vehicle and a server; and a control unit that selects a section with poor sight distance in a road, identifies queue information in an area adjacent to the section with poor sight distance, and provides traffic safety information based on the section with poor sight distance and the queue information

According to an aspect of the present disclosure, a method of providing traffic safety information, which is performed by a computing system, includes: selecting a section with poor sight distance in a road; identifying queue information in an area adjacent to the section with poor sight distance; and providing traffic safety information based on the section with poor sight distance and the queue information.

### BRIEF DESCRIPTION OF THE DRAWINGS

The above and other objects, features and advantages of the present disclosure should become more apparent to those of ordinary skill in the art by describing embodiments thereof in detail with reference to the accompanying drawings, in which:

FIG. 1 is a conceptual diagram illustrating a system for providing traffic safety information according to various embodiments;

FIG. 2 is a block diagram illustrating an apparatus for providing traffic safety information according to various embodiments;

FIG. 3 is a flowchart showing an operation of providing traffic safety information in an apparatus for providing traffic safety information according to various embodiments;

FIGS. 4 and 5 are diagrams for describing a section with poor sight distance and sight distance measurement according to various embodiments;

FIG. 6 is a flowchart showing an operation of generating a queue estimation model in an apparatus for providing traffic safety information according to various embodiments;

FIG. 7 is a diagram for describing generation of the queue estimation model shown in FIG. 6;

FIG. 8 is a flowchart showing an operation of providing a safety event signal in an apparatus for providing traffic safety information according to various embodiments;

FIG. 9 is a diagram for describing the operation of providing a safety event signal shown in FIG. 8; and

FIG. 10 is a flowchart for describing an operation of a system for providing traffic safety information according to various embodiments.

The drawings described herein are for illustration purposes only and are not intended to limit the scope of the present disclosure in any way.

### DETAILED DESCRIPTION

Hereinafter, embodiments of the present disclosure are described in detail with reference to the attached drawings.

However, the technical idea of the present disclosure is not limited to the embodiments described herein, but may be implemented in various different forms, and within the scope of the technical idea of the present disclosure, one or more of the elements may be selectively combined or substituted for use.

Unless otherwise defined, all terms (including technical and scientific terms) used herein have the same meaning as commonly understood by those of ordinary skill in the art to which this disclosure belongs. It should be further understood that terms, such as those defined in commonly used dictionaries, should be interpreted as having a meaning that is consistent with their meaning in the context of the relevant field.

Terms used herein are used to aid in the description and understanding of embodiments and are not intended to limit the scope and spirit of the present disclosure.

It should be understood that the singular forms “a” and “an” also include the plural forms, and expressions such as “at least one (or one or more) of A, B, and C” should be understood as including one or more combination among all combinations of A, B and C. In the present disclosure, each of phrases such as “A or B”, “one of A and B”, “one of A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

In describing the elements of embodiments of the present disclosure, terms such as “first,” “second,” “A,” “B,” “(a),” and “(b)” may be used.

These terms are only used to distinguish a component from other components, and do not limit the essence, rank, or order of the components.

It should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In addition, when one element is referred to as being formed or arranged “on (above) or under (below)” another element, it can be directly in contact with the other element, or intervening elements may be formed or arranged between the two elements. In addition, when an element is described as “on (above) or under (below)” another element, the term “on (above) or under (below)” can encompass both an orientation of above and below.

In the “section with poor sight distance” described in this document, the length of a road that the driver may see ahead is less than or equal to a predetermined threshold value. The threshold value may be specified in advance as a specific value in the system or may be set or changed by a road traffic policy. In other words, the “section with poor sight distance” described in this document may refer to a section where the length of a road that the driver may see ahead is less than or equal to a predetermined threshold value. In this document, ‘poor sight distance’ may also refer to ‘inadequate sight distance’ or ‘insufficient sight distance’. In this description, when a certain component is said to be “adjacent to” another component, this may mean that the certain component is close to, near to, and/or next to the other component, and/or the certain component is disposed within a predetermined distance from the other component.

The “queue” described in this document may be interpreted as information on a specific traffic situation in which a plurality of vehicles are stopped or that satisfies a condition of a predetermined velocity value or lower due to signals or congestion. In this document, ‘queue’ may refer to ‘traffic queue’ or ‘congestion’.

When a component, unit, module, controller, device, element, apparatus, or the like of the present disclosure is described as having a purpose or performing an operation, function, or the like, the component, unit, module, controller, device, element, apparatus, or the like should be considered herein as being “configured to” meet that purpose or to perform that operation or function. Each component, unit, module, controller, device, element, apparatus, and the like may separately embody or be included with a processor and a memory, such as a non-transitory computer readable media, as part of the apparatus. Throughout the present disclosure and claims, where one aspect is said to occur “when” another aspect of the disclosure occurs or has occurred, it can be said that the one aspect occurs “in response to” the other aspect occurring or having occurred.

Throughout the present disclosure and claims, where one aspect is said to occur “when” another aspect of the disclosure occurs or has occurred, it can be said that the one aspect occurs “in response to” the other aspect occurring or having occurred.

Hereinafter, embodiments are described in detail with reference to the accompanying drawings, and the same or corresponding components are assigned the same reference numbers throughout the drawings, and overlapping descriptions of the same elements have been omitted.

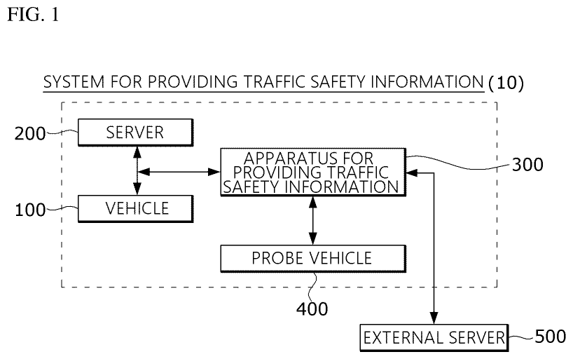

FIG. 1 is a conceptual diagram illustrating a system 10 for providing traffic safety information according to various embodiments.

A system 10 for providing traffic safety information may include a vehicle 100, a server 200, an apparatus 300 for providing traffic safety information, and a probe vehicle 400. The system 10 for providing traffic safety information may perform a function of providing traffic safety services through linkage of traffic light information, congestion information, and road geometry.

The vehicle 100 is a device of transportation that receives traffic safety information according to various embodiments of the present disclosure. The vehicle 100 may receive route information according to route search from the server 200, and may receive comprehensive traffic safety information from the server 200 or the apparatus 300 for providing traffic safety information. To this end, the vehicle 100 may share data (e.g., route search data, image recognition information) for receiving the route information and the traffic safety information by communicating with at least a part of a configuration of the system 10 for providing traffic safety information or an external server 500.

The server 200 is an apparatus or program that provides navigation information including traffic safety information to the vehicle 100. The server 200 may provide the navigation information to the vehicle 100 in response to receiving a route generation request according to a departure/destination of the vehicle 100. In addition, the server 200 may transmit a road geometry database (DB) (e.g., MAP information, geographical information, and the like) for determining a section with poor sight distance to the apparatus 300 for providing traffic safety information, and may provide traffic safety information received from the apparatus 300 for providing traffic safety information to the vehicle 100.

The apparatus 300 for providing traffic safety information performs a function of generating traffic safety information based on a section with poor sight distance and queue information and providing the generated traffic safety information to the vehicle 100 or the server 200. Although the apparatus 300 for providing traffic safety information is illustrated as a separate apparatus distinct from the vehicle 100 and the server 200, according to various embodiments, the apparatus 300 for providing traffic safety information may be configured to be included in the vehicle 100 or the server 200. For example, configurations and embodiments of a control unit 320 and a storage unit 330 of the apparatus 300 for providing traffic safety information may be included in or replaced by a control unit and a storage unit of the vehicle 100 or the server 200. In addition, a communication unit 310 of the apparatus 300 for providing traffic safety information may be included in or replaced by at least a part of a configuration of a communication unit of the vehicle 100 or the server 200.

The apparatus 300 for providing traffic safety information may receive location information, velocity information, image information, and the like of the vehicle 100 or the probe vehicle 400 from the vehicle 100 or the server 200 in real time, periodically, or at any arbitrary point in time.

The probe vehicle 400 is a vehicle equipped with an apparatus that may provide a third party with a location of the probe vehicle 400 and route information through which the probe vehicle passes through a road network. The system 10 for providing traffic safety information according to various embodiments of the present disclosure may generate traffic safety information by utilizing a probe vehicle that provides a connected car service. For this, the probe vehicle 400 may be equipped with a telematics terminal as a vehicle terminal. The probe vehicle 400 may obtain a distance from a preceding or following vehicle through a sensor, and share data by being connected to adjacent probe vehicles 400 via communication.

In description of at least some of the various embodiments described in the present disclosure, the vehicle 100 may be assumed to be a probe vehicle 400.

The external server 500 provides the system 10 for providing traffic safety information with various types of information to generate traffic safety information. For example, the external server 500 may include a server of the National Police Agency Urban Traffic Center that provides traffic light information, including signal cycles and current display information, as well as closed-circuit television (CCTV) video information. In addition, the external server 500 may provide a road geometry DB to the system 10 for providing traffic safety information, separately from the server 200.

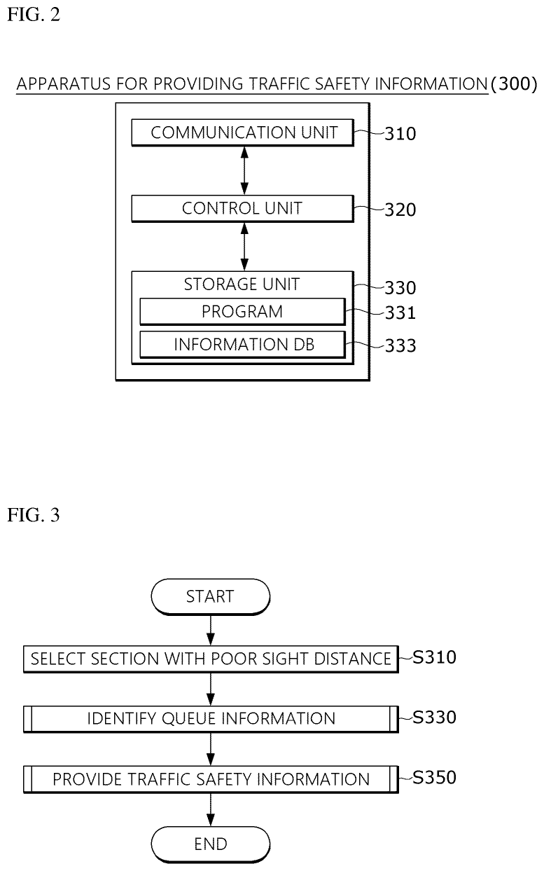

FIG. 2 is a block diagram illustrating an apparatus 300 for providing traffic safety information according to various embodiments.

The apparatus 300 for providing traffic safety information may include a communication unit 310, a control unit 320, and a storage unit 330.

The communication unit 310 communicatively connects the apparatus 300 for providing traffic safety information with at least one of the vehicle 100, the server 200, the probe vehicle 400, and the external server 500. The communication unit 310 may include at least one of a mobile communication module, a wireless Internet module, and a short-range communication module.

According to one embodiment, the mobile communication module may communicate with at least a part of a configuration of the system 10 for providing traffic safety information or the external server 500 through a mobile communication network constructed according to technical standards or communication methods for mobile communication (e.g., global system for mobile communication (GSM), code division multi access (CDMA), CDMA2000, enhanced voice-data optimized or enhanced voice-data only (EV-DO), wideband CDMA (WCDMA), high speed downlink packet access (HSDPA), high speed uplink packet access (HSUPA), Long Term Evolution (LTE), Long Term Evolution-Advanced (LTE-A), and the like), 4^{th} Generation (4G) mobile telecommunication, 5th generation (5G) mobile telecommunication, and the like.

According to one embodiment, the wireless Internet module is a module for wireless Internet access, and may communicate with at least a part of a configuration of the system 10 for providing traffic safety information or the external server 500 through a wireless local area network (WLAN), wireless fidelity (WiFi), WiFi Direct, a digital living network alliance (DLNA), a wireless broadband (WiBro), world interoperability for microwave access (WiMAX), HSDPA, HSUPA, LTE, LTE-A, and the like.

According to one embodiment, the short-range communication module may support short-range communication using at least one of Bluetooth™, radio frequency identification (RFID), Infrared Data Association (IrDA), ultra wideband (UWB), ZigBee, near field communication (NFC), and wireless Universal Serial Bus (wireless USB) technologies.

The control unit 320 may control the overall operation of the apparatus 300 for providing traffic safety information and the signal flow between internal components of the apparatus 300 for providing traffic safety information and perform a data processing function for processing data. The control unit 320 may include at least one processor.

The processor may execute instructions stored in a memory of the storage unit 330 to generate information or control the components of the apparatus 300 for providing traffic safety information. The processor may be configured to include a central processing unit (CPU), a micro-processor unit (MPU), a micro controller unit (MCU), a graphics processing unit (GPU), or any type of processor well known in the art of the present disclosure.

The storage unit 330 may store data received from or generated by the control unit 320, or other components of the apparatus 300 for providing traffic safety information or the system 10 for providing traffic safety information. The storage unit 330 may include, for example, a memory, a cache, a buffer, and the like, and may be composed of software, firmware, hardware, or a combination of at least two thereof. The memory may store instructions related to the control of the apparatus 300 for providing traffic safety information and data for generating information.

According to various embodiments, the storage unit 330 may include a program 331 and an information DB 333.

The program 331 may include various types of algorithms and instructions for extracting sections with poor sight distance, identifying queues, artificial intelligence (AI) learning based on CCTV video information and probe vehicle information, generating a queue estimation model, and generating comprehensive traffic safety information according to various embodiments of the present disclosure.

The information DB 333 may include comprehensive traffic safety information and data shared or generated through the system 10 for providing traffic safety information or the external server 500 to generate the comprehensive traffic safety information. For example, the information DB 333 may store traffic light information (e.g., signal cycles and current display information, and the like), CCTV video information, and the like collected from the external server 500, such as a server of the National Police Agency Urban Traffic Center, and may store a road geometry DB received from the server 200. In addition, the information DB 333 may store information such as sensor information, trajectory information, and number information collected through the vehicle 100 or the probe vehicle 400. According to various embodiments, the information DB 333 may store a first event signal, a second event signal, and the like that transmit a notification or a control signal to the vehicle 100 as a component of the traffic safety information.

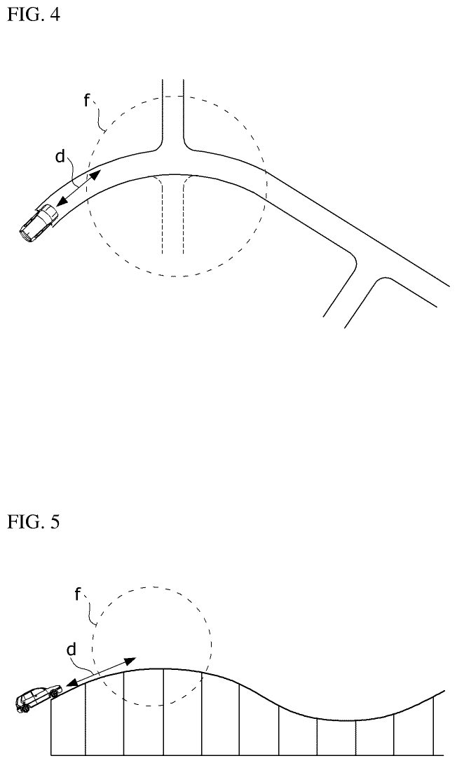

FIG. 3 is a flowchart showing an operation of providing traffic safety information in an apparatus for providing traffic safety information according to various embodiments. At least some of the operations disclosed in FIG. 3 may be omitted or performed in a changed order, and in various embodiments of the present disclosure, specific operations may be added. In addition, the subject performing each operation of FIG. 3 is described as the apparatus 300 for providing traffic safety information, but it is not limited thereto, and each operation may be performed by at least one of the control unit 320 of the apparatus 300 for providing traffic safety information, instructions of the memory 330 of the apparatus 300 for providing traffic safety information, a processor implemented in the vehicle 100 or the server 200, and instructions stored in a memory.

According to various embodiments, the apparatus 300 for providing traffic safety information may select a section with poor sight distance (operation S310).

In a section with poor sight distance, the length of the road that the driver may see ahead is limited. The apparatus 300 for providing traffic safety information may select a section with poor sight distance through navigation map information and road geometry information, such as 3D geographic information, or may extract a section with poor sight distance based on image recognition information, such as a specific obstacle recognized by the vehicle 100 or the probe vehicle 400.

For this, reference is made to FIGS. 4 and 5. FIGS. 4 and 5 are diagrams illustrating sections f with poor sight distance, which are extracted from a horizontal alignment and a vertical alignment through a road geometry DB, and sight distances d measured from the horizontal alignment and the vertical alignment.

The apparatus 300 for providing traffic safety information may extract at least one section f with poor sight distance according to a pre-determined policy by referring to the horizontal alignment shown in FIG. 4 and the vertical alignment shown in FIG. 5 based on the road geometry DB that may be collected through the server 200 or the external server 500 or pre-stored in the storage unit 330. The selection of the section f with poor sight distance may be automatically selected through an image recognition algorithm that determines the slope of the road, the bending of the curve, and the like, and a designation of a certain range of areas according to a specific location, or may be selected by a user input, and the like. In addition, the selection may be achieved by referring to a poor sight distance section DB selected in advance according to various policies. The section f with poor sight distance may be extracted as a specific area in an image or as a specific coordinate section.

As illustrated in FIGS. 4 and 5, the apparatus 300 for providing traffic safety information may measure a sight distance d of the vehicle driver at the section f with poor sight distance or an arbitrary point in a section adjacent to the section f with poor sight distance. The operation of measuring the sight distance d of the vehicle driver may be performed in real time, periodically, or at various arbitrary points in time according to the movement of the vehicle 100.

An example of the method of obtaining the sight distance is as follows. Assuming that the sight distance d is a stop sight distance D, it may be calculated as follows.

$$D = {d}_{1} + {d}_{2} = \frac{V}{3.6} t + \frac{{V}^{2}}{254 f} = 0.694 V + \frac{{V}^{2}}{254 f}$$

$$D : stop sight distance ( m )$$

$$d 1 : distance travelled during reaction time ( m )$$

$$d 2 : braking distance ( m )$$

$$V : driving velocity ( km / h )$$

$$t : reaction time ( typically 1 to 2.5 seconds )$$

$$f : longitudinal sliding friction coefficient in wet road condition$$

However, the method of calculating the stop sight distance D may vary depending on the road conditions (e.g., when there is a vertical slope, and the like) and may be changed differently by user settings, and the like.

Referring to FIG. 3 again, the apparatus 300 for providing traffic safety information may identify queue information (operation S330).

The apparatus 300 for providing traffic safety information may identify real-time queues from sections such as a signal intersection or a traffic congestion section. For example, when a plurality of vehicles is stopped or move at a predetermined velocity or less due to signals or congestion in an arbitrary road section, the apparatus 300 for providing traffic safety information may identify the corresponding section as queue information.

According to various embodiments, the apparatus 300 for providing traffic safety information may identify the queue information based on at least one of traffic light information, CCTV video information, and probe vehicle information.

The apparatus 300 for providing traffic safety information may identify the queue information in real time through the CCTV video information. For example, the apparatus 300 for providing traffic safety information may collect images collected from CCTVs of the road through the external server 500, and may identify the length of a queue of vehicles in traffic congestion using a tool, such as deep learning-based XGBoost (eXtreme Gradient Boosting) or convolutional neural networks (CNNs). For the criteria of traffic congestion, a range of values of vehicles with a predetermined velocity or less or with an interval between a predetermined number of vehicles that is lower than or equal to a predetermined value may be set in advance, but the disclosure is not limited thereto, and the presence or absence and the length of the queue of vehicles that are in traffic congestion may be calculated based on various criteria.

The apparatus 300 for providing traffic safety information may identify a relatively accurate queue length through the CCTV video information as described above. However, given limitations and variables occurring in real-time collection of CCTV images, when a queue estimation model is generated by learning data in advance based on AI, an approximate length of a queue may be estimated at a later time using only specific information (e.g., probe vehicle information).

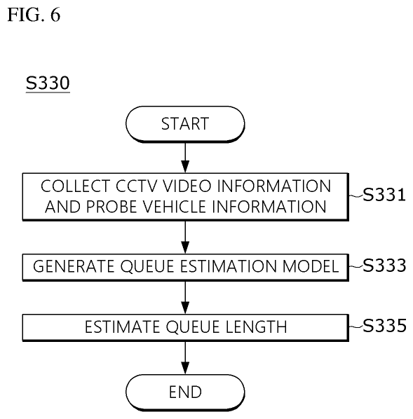

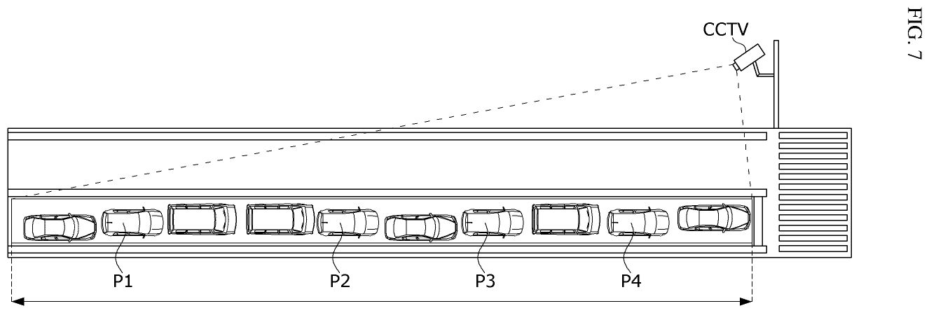

Specifically, the apparatus 300 for providing traffic safety information may generate a queue estimation model. For this, reference is made to FIGS. 6 and 7. FIG. 6 is a flowchart showing an operation of generating a queue estimation model in an apparatus for providing traffic safety information according to various embodiments. FIG. 7 is a diagram for describing generation of the queue estimation model shown in FIG. 6.

In operation S331 of FIG. 6, the apparatus 300 for providing traffic safety information may collect CCTV video information and probe vehicle information. In particular, to generate a queue estimation model based on AI deep learning, each of the CCTV video information and the probe vehicle information may be composed of a plurality of pieces of accumulated data.

Referring to FIG. 7, a queue congested on a road is illustrated. In FIG. 7, probe vehicles P1, P2, P3, and P4 to which vehicle driving information at a specific point in a specific section is connected and general vehicles from which information is not collected are mixed.

The apparatus 300 for providing traffic safety information may collect an image of a queue, as shown in FIG. 7, collected from a CCTV device, through the external server 500, and may identify the actual queue length based on the collected CCTV video. The actual queue length may be calculated or identified in a DB, for example, based on the specification information of video coverage of images collected from the CCTV device, an image analysis algorithm, and the length of a specific section known in advance.

In addition, the apparatus 300 for providing traffic safety information may identify probe vehicle information from the probe vehicles P1, P2, P3, and P4 included in the collected CCTV video. The probe vehicle information may include, for example, at least one of trajectory positions of probe vehicles, the number of probe vehicles, and information about an interval between probe vehicles.

The apparatus 300 for providing traffic safety information may implement a queue estimation model that may estimate a queue length by learning accumulated CCTV videos, which may identify the actual queue length as described above, and pieces of probe vehicle information included in each of the CCTV videos (operation S333).

For example, the apparatus 300 for providing traffic safety information may generate a queue estimation model by learning pieces of actual queue length information identified from accumulated CCTV videos in a specific congestion section, as shown in FIG. 7, and pieces of probe vehicle information included in each of the CCTV videos using an AI tool, such as XGBoost. In the learning process, feature values may be set as trajectory positions of probe vehicles, the number of probe vehicles, and the interval between probe vehicles, and the actual queue length may be designated as a label value.

When the generation of the queue estimation model is completed, the apparatus 300 for providing traffic safety information may estimate the queue length only with probe vehicle information without CCTV videos (operation S335). For example, the apparatus 300 for providing traffic safety information may collect real-time or new probe vehicle information in a specific section and apply the collected probe vehicle information to the queue estimation model, thereby inferring the length of a real-time queue. In this case, the probe vehicle information may include information about the number of the probe vehicles 400 and information about the interval between the probe vehicles 400 as described above.

According to various embodiments, the apparatus 300 for providing traffic safety information may selectively provide first queue information identified based on CCTV video information or second queue information estimated through the queue estimation model according to a predetermined condition.

For example, when there is no probe vehicle 400 in a specific section, it may be difficult to employ the queue estimation model. In this case, the apparatus 300 for providing traffic safety information may provide queue information identified through CCTV video information without collecting probe vehicle information, or traffic safety information based on the identified queue information to the vehicle 100 or the server 200.

As another example, a vehicle driver notified of the presence of a queue ahead may request that the length of the queue is more accurately identified. In this case, the apparatus 300 for providing traffic safety information may provide the vehicle 100 or server 200 with the length of the queue identified through CCTV video information, rather than the length of the queue estimated by the queue estimation model, or traffic safety information based on the identified length of the queue.

As described above, when one of the CCTV video information and the probe vehicle information is missing or has insufficient reliability, the apparatus 300 for providing traffic safety information may selectively provide one of the first queue information based on the CCTV video information and the second queue information based on the queue estimation model, automatically or according to a user's selection.

Referring to FIG. 3 again, the apparatus 300 for providing traffic safety information may provide traffic safety information to the vehicle 100 or the server 200 (operation S350).

The traffic safety information may be, for example, at least one of a section with poor sight distance, queue information, a queue estimation model, and traffic light information, or comprehensive traffic safety information generated based on the information.

For example, the apparatus 300 for providing traffic safety information may provide extracted sections with poor sight distance, information about queues collected from traffic lights ahead or intersection information, and the like to the vehicle 100 or the server 200.

According to various embodiments, the apparatus 300 for providing traffic safety information may generate a safety event signal and provide the generated safety event signal to the vehicle 100 or the server 200. The safety event signal may be specific traffic safety information generated according to a predetermined condition.

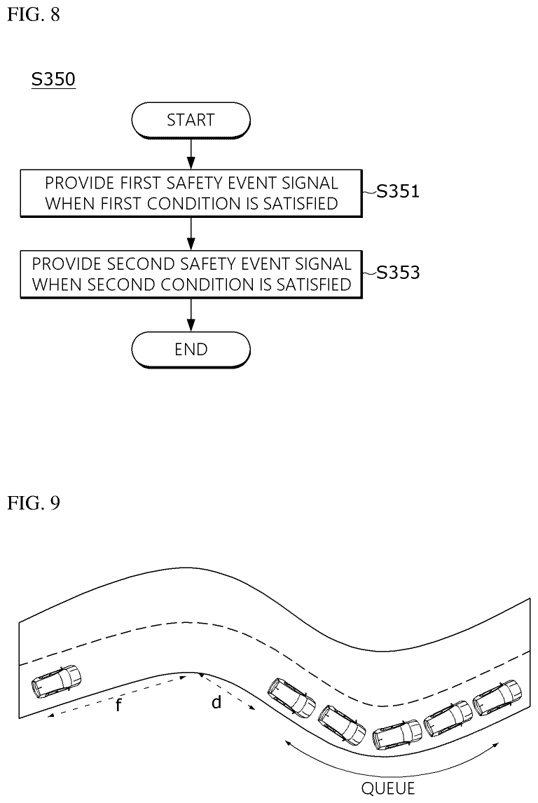

Specifically, the apparatus 300 for providing traffic safety information may generate different safety event signals according to a predetermined condition and provide at least one of the generated different safety event signals to the vehicle 100 or the server 200. An embodiment is specifically described with reference to FIGS. 8 and 9. FIG. 8 is a flowchart specifically describing operation S350 shown in FIG. 3, and FIG. 9 is a diagram referenced for describing FIG. 8.

Referring to FIG. 8, the apparatus 300 for providing traffic safety information may generate a first safety event signal related to a notification when a first condition is satisfied, and provide the generated first safety event signal (operation S351). The first condition may be, for example, at least one of whether the vehicle 100 has entered a section with poor sight distance and whether queue information is identified within a predetermined range from the section with poor sight distance, and the first safety event signal may be information related to a notification.

Specifically, the apparatus 300 for providing traffic safety information may, when the vehicle 100 has entered a section f with poor sight distance, provide the vehicle 100 or the server 200 with a first safety event signal for causing notification content related to sight distance information, text, audio, an image, or video to be generated and output to the driver of the vehicle 100, as shown in FIG. 9. In this case, the first condition may include not only whether the vehicle 100 has entered a section f with poor sight distance, but also whether queue information within a predetermined range from the section f with poor sight distance is present. The first safety event signal may be generated in advance for each scenario and stored in the storage unit 330 in advance, or may be generated when the corresponding event occurs.

As described above, the first safety event signal may be information related to a notification instructing to slow down and drive slowly or stop because a section with poor sight distance ahead and queue information are identified. The first safety event signal may be a data signal in which the notification-related information as described above is configured in the form of text, an image, or audio, or a control signal that causes the vehicle 100 or the server 200 to convert the notification-related information as described above into a signal in the form of text, an image, or audio.

According to various embodiments, the apparatus 300 for providing traffic safety information may, when a second condition is satisfied, generate a second safety event signal and provide the generated second safety event signal (operation S353). The second condition may be, for example, whether the distance between the vehicle 100 and the queue is less than or equal to a predetermined value (e.g., a specific stop sight distance value), and the second safety event signal may be a control signal that controls the driving (e.g., deceleration) of the vehicle 100. For example, as shown in FIG. 9, when a vehicle 100 enters a section with poor sight distance and the distance between the vehicle 100 and the queue or the stop sight distance of the vehicle 100 at the point is less than or equal to a predetermined value, the apparatus 300 for providing traffic safety information may generate a driving control signal causing the velocity of the vehicle 100 to be controlled, and transmit the generated driving control signal to the vehicle 100 or the server 200.

By providing passive traffic safety services and active traffic safety services based on different conditions as described above, more efficient traffic safety services related to sections with poor sight distance may be provided.

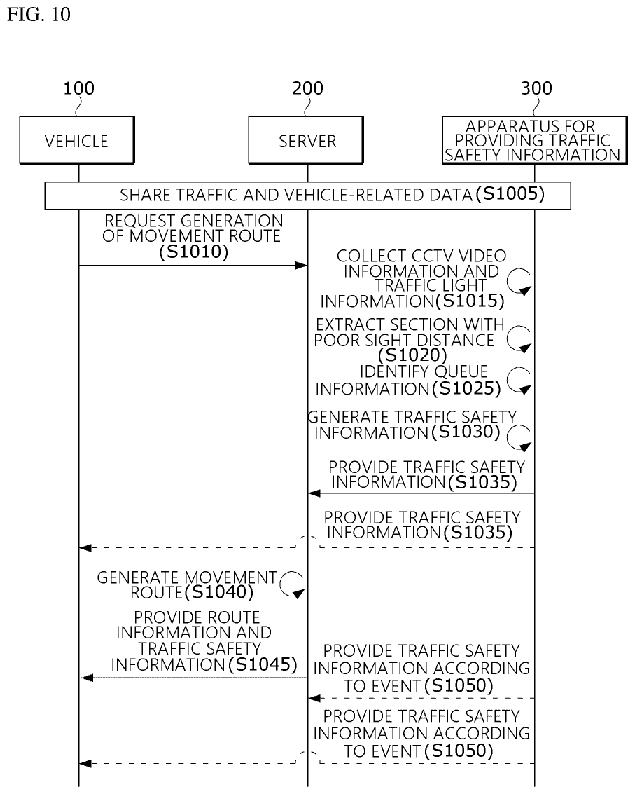

FIG. 10 is a flowchart for describing an operation of a system 10 for providing traffic safety information according to various embodiments.

The system 10 for providing traffic safety information described in FIG. 10 may include a vehicle 100, a server 200, and an apparatus 300 for providing traffic safety information, and for the convenience of description, an external server 500 is additionally described. At least some of the operations disclosed in FIG. 10 may be omitted or may be performed in a changed order, and in various embodiments of the present disclosure, specific operations may be added.

For convenience of description, it is assumed that the vehicle 100 described in FIG. 10 has the characteristics of a probe vehicle 400. In addition, embodiments described through FIGS. 1-9 may be equally applied to each operation disclosed in FIG. 10.

First, the vehicle 100, the server 200, and the apparatus 300 for providing traffic safety information may share traffic and vehicle-related data (operation S1005). For example, the vehicle 100 may provide at least one of trajectory data, route search data, image recognition information, and sensor information collected through a sensor to the server 200 and the apparatus 300 for providing traffic safety information.

The vehicle 100 may request the server 200 to generate a movement route according to a departure/destination (operation S1010).

The apparatus 300 for providing traffic safety information may receive CCTV video information and traffic light information from the external server 500 (operation S1015).

The apparatus 300 for providing traffic safety information may process required data in stages based on the information collected from the vehicle 100, the server 200, and the external server 500.

The apparatus 300 for providing traffic safety information may extract a section with poor sight distance (operation S1020).

The apparatus 300 for providing traffic safety information may identify queue information (operation S1025). In order to identify the queue information, the apparatus 300 for providing traffic safety information may identify the length of the queue in real time, or after implementing a queue estimation model, estimate the length of the queue by reflecting further probe vehicle information.

The apparatus 300 for providing traffic safety information may generate traffic safety information for determining the safety level of the section with poor sight distance based on at least one of the section with poor sight distance, traffic light information, and queue information (operation S1030). The traffic safety information may include a safety event signal (e.g., a first safety event signal, a second safety event signal) that is independently generated according to a predetermined condition.

The apparatus 300 for providing traffic safety information may provide the generated traffic safety information to the vehicle 100 or the server 200 (operation S1035). The apparatus 300 for providing traffic safety information may provide the vehicle 100 or the server 200 with comprehensive traffic safety information, including information on a section with poor sight distance, queue information, traffic light information, and probe vehicle information, which have been considered to configure traffic safety information, and the traffic safety information. The transmission of such information may occur once, but it is also possible to transmit such information a plurality of times in real time, periodically, or at an arbitrary point in time.

The server 200 may generate a movement route according to a departure/destination according to a request received from the vehicle 100 (S1040), and transmit the generated movement route information and comprehensive traffic safety information to the vehicle 100 (operation S1045).

According to various embodiments, the server 200 may transmit the comprehensive traffic safety information such that the time and range for transmitting the comprehensive traffic safety information to the vehicle 100 are selectively set according to the location or movement route of the vehicle 100.

For example, the server 200 may provide the vehicle 100 with comprehensive traffic safety information within a predetermined area range based on the location of the vehicle 100 that changes in real time according to the movement of the vehicle 100. Accordingly, comprehensive traffic safety information corresponding to at least a part of the entire movement route of the vehicle 100 may be intermittently provided to the vehicle 100.

As another example, the server 200 may, in a case when the vehicle 100 enters a section with poor sight distance or when queue information is identified after entering a section with poor sight distance, provide comprehensive traffic safety information corresponding to the case.

Embodiments described in operation S1045 may also be applied when the comprehensive traffic safety information is transmitted from the apparatus 300 for providing traffic safety information to the vehicle 100 or the server 200 in operation S1035. However, the disclosure is not limited thereto, and it is also possible for the server 200 or the apparatus 300 for providing traffic safety information to provide all information to the vehicle 100 at one time.

The apparatus 300 for providing traffic safety information may generate additional traffic safety information according to an occurrence of a predetermined event and provide the additional traffic safety information to the vehicle 100 or the server 200 (operation S1050). The apparatus 300 for providing traffic safety information may selectively generate a first safety event signal and a second safety event signal according to a first condition and a second condition and provide the first safety event signal and the second safety to the server 200 or the vehicle 100.

In the present specification, “unit” includes a unit realized by hardware, a unit realized by software, and a unit realized using both. Further, one unit may be realized by using two or more pieces of hardware, or two or more units may be realized by one piece of hardware. It should, however, be understood that the term “unit” is not limited to a software or hardware element. A “unit” may be implemented in addressable storage media. A “unit” may also be configured to reproduce one or more processors. For example, a “unit” may include various types of elements (e.g., software elements, object-oriented software elements, class elements, task elements, and the like), segments (e.g., processes, functions, attributes, procedures, sub-routines, program code, and the like), drivers, firmware, micro-code, circuits, data, databases, data structures, tables, arrays, variables, and the like. Functions provided by elements and “units” may be formed by combining them into a smaller number of elements and “units” or may be divided into additional elements and “units.” In addition, elements and “units” may also be implemented to reproduce one or more CPUs in devices or security multi-cards.

As is apparent from the above, according to an embodiment of the present disclosure, by identifying the section with poor sight distance and the queue information ahead and providing the traffic safety information, the driver can recognize the queue ahead in advance and respond to the queue. Accordingly, by slowing down in response to unexpected traffic congestion, traffic accidents can be reduced.

In addition, by providing a queue estimation model that can estimate the length of the queue, traffic congestion information ahead can be inferred more easily.

Furthermore, by passively/actively providing traffic safety information for notifying or controlling vehicles at risk of collision in a section with poor sight distance, the occurrence of vehicle safety accidents can be minimized.

Although embodiments of the present disclosure have been described in detail above with reference to the accompanying drawings, those of ordinary skill in the technical field to which the present disclosure pertains should be able to understand that various modifications and alterations may be made without departing from the technical spirit or essential features of the present disclosure.

What is claimed is:

1. An apparatus for providing traffic safety information, the apparatus comprising:
a communication unit configured to communicate with at least one of a vehicle and a server; and
a control unit configured to select a section with poor sight distance in a road, identify queue information in an area adjacent to the section with poor sight distance, and provide traffic safety information based on the section with poor sight distance and the queue information.

2. The apparatus of claim 1, wherein the control unit is further configured to select the section with poor sight distance based on at least one of image recognition information or road geometry information.

3. The apparatus of claim 1, wherein the control unit is further configured to identify the queue information based on at least one of closed-circuit television (CCTV) video information and probe vehicle information about a probe vehicle which is communicable with the communication unit.

4. The apparatus of claim 1, wherein the control unit is further configured to generate a queue estimation model based on accumulated CCTV video information of a specific queue section and accumulated probe vehicle information of the specific queue section.

5. The apparatus of claim 4, wherein the control unit is further configured to collect new probe vehicle information of the specific queue section and apply the collected new probe vehicle information to the queue estimation model to estimate a length of a queue.

6. The apparatus of claim 5, wherein the control unit is further configured to selectively provide, based on a predetermined condition, one of first queue information identified based on the CCTV video information or second queue information estimated through the queue estimation model.

7. The apparatus of claim 1, wherein the control unit is further configured to provide the traffic safety information further based on traffic light information.

8. The apparatus of claim 1, wherein the control unit is further configured to generate different safety event signals based on a predetermined condition and provide the traffic safety information including at least one of the generated different safety event signals.

9. The apparatus of claim 8, wherein the control unit is further configured to provide a first safety event signal related to a notification in response to the vehicle satisfying a first condition.

10. The apparatus of claim 9, wherein the control unit is further configured to provide a second safety event signal related to driving of the vehicle in response to the vehicle satisfying a second condition.

11. A method of providing traffic safety information, which is performed by a computing system, the method comprising:
selecting a section with poor sight distance in a road;
identifying queue information in an area adjacent to the section with poor sight distance; and
providing traffic safety information based on the section with poor sight distance and the queue information.

12. The method of claim 11, wherein selecting the section with poor sight distance includes selecting the section with poor sight distance based on at least one of image recognition information or road geometry information.

13. The method of claim 11, wherein identifying the queue information includes identifying the queue information based on at least one of closed-circuit television (CCTV) video information and probe vehicle information.

14. The method of claim 11, wherein identifying the queue information includes generating a queue estimation model based on accumulated CCTV video information of a specific queue section and accumulated probe vehicle information of the specific queue section.

15. The method of claim 14, wherein identifying the queue information includes collecting new probe vehicle information of the specific queue section and applying the collected new probe vehicle information to the queue estimation model to estimate a length of a queue.

16. The method of claim 15, further comprising selectively providing, based on a predetermined condition, one of first queue information identified based on the CCTV video information or second queue information estimated through the queue estimation model.

17. The method of claim 11, wherein the traffic safety information is generated based on traffic light information.

18. The method of claim 11, wherein providing the traffic safety information includes:
generating different safety event signals based on a predetermined condition; and
providing the traffic safety information including at least one of the generated different safety event signals.

19. The method of claim 18, wherein providing the traffic safety information includes providing a first safety event signal related to a notification when a vehicle satisfies a first condition.

20. The method of claim 19, wherein providing the traffic safety information includes providing a second safety event signal related to driving when the vehicle satisfies a second condition.
